(19) United States
(12) Patent Application Publication
(10) Pub. No.: US 2025/0272893 A1
(43) Pub. Date: Aug. 28, 2025

(54) INFORMATION DISPLAY METHOD, APPARATUS, MEDIUM, ELECTRONIC DEVICE AND PROGRAM PRODUCT

(71) Applicant: Beijing Volcano Engine Technology Co., Ltd., Beijing (CN)

(72) Inventors: Meitong YAN, Beijing (CN); Jian QIU, Beijing (CN); Xiangshu LI, Beijing (CN); Sijie SHAN, Beijing (CN); Feng QIAN, Beijing (CN); Songming CHEN, Beijing (CN); Yinlong ZHU, Beijing (CN); Huan WANG, Beijing (CN); Bingshu JIN, Beijing (CN); Cheng GU, Beijing (CN); Jiaming LI, Beijing (CN); Weiying YU, Beijing (CN)

(21) Appl. No.: 19/066,416

(22) Filed: Feb. 28, 2025

(30) Foreign Application Priority Data
Feb. 28, 2024 (CN) 202410227558.7

(51) Int. Cl. G06T 11/20; G06Q 30/0201; G06T 11/00

(52) U.S. Cl. CPC G06T 11/206; G06Q 30/0201; G06T 11/001

(57) ABSTRACT

The present disclosure relates to an information display method, an apparatus, a medium, an electronic device and a program product. The method includes: displaying charts corresponding to different channel scenarios in response to a trigger operation for conversion analysis of a target business in an information display page; where the target business includes a plurality of business process nodes, and a chart corresponding to a channel scenario includes a maximum churn rate among all business process nodes in the channel scenario determined based on data corresponding to the channel scenario. The displayed chart includes the maximum churn rate among all the business process nodes in the channel scenario determined based on the data corresponding to the channel scenario.

### CROSS-REFERENCE TO RELATED APPLICATIONS

This application claims the priority to and benefits of Chinese Patent Application No. 202410227558.7, filed on Feb. 28, 2024, which is incorporated herein by reference in its entirety.

### TECHNICAL FIELD

The present disclosure relates to the field of electronic information technology, and in particular, to an information display method, an apparatus, a medium, an electronic device and a program product.

### BACKGROUND

With the rapid development of electronic information technology, it is widely used to perform conversion analysis on user behavior data collected in applications, and to gain insight into current situation and problems of the applications in combination with analysis results, so as to provide directions for subsequent iteration and optimization of the applications.

The analysis results are usually displayed in the form of charts. In the charts in the related art, it is necessary to check business process nodes one by one and calculate relevant data manually, so as to obtain certain information, which leads to high cost of insight problem search.

### SUMMARY

This Summary is provided to introduce concepts in a simplified form that are described in detail in the following Detailed Description section. This Summary section is not intended to identify key features or essential features of the claimed technical solution, nor is it intended to be used to limit the scope of the claimed technical solution.

In a first aspect, the present disclosure provides an information display method, including:
displaying charts corresponding to different channel scenarios in response to a trigger operation for conversion analysis of a target business in an information display page;
where the target business includes a plurality of business process nodes, and a chart corresponding to a channel scenario includes a maximum churn rate among all business process nodes in the channel scenario determined based on data corresponding to the channel scenario.

In a second aspect, the present disclosure provides an information display apparatus, including:
a display module configured to display charts corresponding to different channel scenarios in response to a trigger operation for conversion analysis of a target business in an information display page;
where the target business includes a plurality of business process nodes, and a chart corresponding to a channel scenario includes a maximum churn rate among all business process nodes in the channel scenario determined based on data corresponding to the channel scenario.

In a third aspect, the present disclosure provides a computer-readable medium having a computer program stored thereon, which, when executed by a processing apparatus, implements the steps of the method of any one of claims 1-15.

In a fourth aspect, the present disclosure provides an electronic device, including:
a storage apparatus having a computer program stored thereon;
a processing apparatus configured to execute the computer program in the storage apparatus to implement the steps of the method of the first aspect.

In a fifth aspect, the present disclosure provides a computer program product including a computer program, which, when executed by a processor, implements the steps of the method of the first aspect.

With the above technical solutions, the displayed chart includes the maximum churn rate among all the business process nodes in the channel scenario determined based on the data corresponding to the channel scenario, so that the maximum churn rate can be obtained from the chart intuitively without manual calculation, thereby improving the efficiency of insight problem search and reducing the cost of insight problem search.

Other features and advantages of the present disclosure will be described in detail in the following Detailed Description section.

### BRIEF DESCRIPTION OF DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is a flowchart of an information display method according to an exemplary embodiment of the present disclosure;

FIG. 2A is a schematic diagram of a chart in the related art;

FIG. 2B is a schematic diagram of a chart according to an exemplary embodiment of the present disclosure;

FIG. 3A is a schematic diagram of a chart in the related art;

FIG. 3B is a schematic diagram of a chart according to an exemplary embodiment of the present disclosure;

FIG. 4 is a schematic diagram of a comparison component according to an exemplary embodiment of the present disclosure;

FIG. 5 is a schematic diagram of a comparison component according to an exemplary embodiment of the present disclosure;

FIG. 6 is a schematic diagram of displaying conversion results of respective business process nodes in a chart displayed in a funnel graphic display type according to an exemplary embodiment of the present disclosure;

FIG. 7 is a schematic diagram of charts corresponding to different channel scenarios displayed in different color styles according to an exemplary embodiment of the present disclosure;

FIG. 8A is a schematic diagram of a chart in the related art;

FIG. 8B is a schematic diagram of a chart according to an exemplary embodiment of the present disclosure;

FIG. 9A is a schematic diagram of a chart in the related art;

FIG. 9B is a schematic diagram of a process of modifying a name of a certain business process node in a chart of a certain channel scenario displayed in a chart display region.

FIG. 10A is a schematic diagram of a chart in the related art.

FIG. 10B is a schematic diagram of a process of adjusting sorting among a plurality of business process nodes in a chart of a certain channel scenario displayed in a chart display region.

FIG. 11A is a schematic diagram of a chart in the related art.

FIG. 11B is a schematic diagram of deleting a certain business process node in a chart of a certain channel scenario displayed in a chart display region.

FIG. 12A is a schematic diagram of a chart in the related art.

FIG. 12B is a schematic diagram of triggering configuration of a filter condition for a business process node in the business process node in a certain chart displayed in the display region.

FIG. 13 is a schematic diagram of a process of configuring a filter condition for a business process node in the business process node according to an exemplary embodiment of the present disclosure.

FIG. 14 is a schematic diagram of deleting a first target channel scenario according to an exemplary embodiment of the present disclosure.

FIG. 15 is a schematic diagram of adding a second target channel scenario according to an exemplary embodiment of the present disclosure.

FIG. 16 is a block diagram of an information display apparatus according to an exemplary embodiment of the present disclosure.

FIG. 17 is a structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of the present disclosure.

It should be understood that the various steps recited in the method implementations of the present disclosure may be performed in a different order and/or in parallel. Furthermore, the method implementations may include additional steps and/or omit performing the illustrated steps. The scope of the present disclosure is not limited in this respect.

As used herein, the term “include/include” and variations thereof are open-ended inclusions, that is, “include/include but not limited to”. The term “based on” is “at least partially based on”. The term “an embodiment” means “at least one embodiment”; the term “another embodiment” means “at least one additional embodiment”; the term “some embodiments” means “at least some embodiments”. Relevant definitions of other terms will be given in the description below.

It should be noted that the concepts such as “first” and “second” mentioned in the present disclosure are only used to distinguish different apparatuses, modules or units, and are not used to limit the order or interdependence of functions performed by these apparatuses, modules or units.

It should be noted that the modifiers “one” and “a plurality” mentioned in the present disclosure are intended to be illustrative rather than limiting, and those skilled in the art should understand that unless the context clearly indicates otherwise, they should be understood as “one or more”.

The names of messages or information exchanged between apparatuses in the implementations of the present disclosure are only for illustrative purposes, and are not intended to limit the scope of these messages or information.

It should be understood that before using the technical solutions disclosed in the embodiments of the present disclosure, the user should be informed of the type, scope of use, usage scenarios, etc. of personal information involved in the present disclosure in an appropriate manner in accordance with relevant laws and regulations, and the authorization of the user should be obtained.

For example, when an active request from a user is received, prompt information is sent to the user to clearly inform the user that the operation requested by the user will require access to and use of the user's personal information. Therefore, the user can independently choose whether to provide the personal information to software or hardware such as an electronic device, an application, a server or a storage medium that performs the operations of the technical solutions of the present disclosure, according to the prompt information.

As an optional but non-limiting implementation, the manner of sending the prompt information to the user in response to receiving the active request from the user may be, for example, in the form of a pop-up window, and the prompt information may be presented in text in the pop-up window. In addition, the pop-up window may also carry a selection control for the user to choose “agree” or “disagree” to provide the personal information to the electronic device.

It should be understood that the above process of notifying and acquiring the authorization of the user is only illustrative, and does not constitute a limitation on the implementations of the present disclosure. Other manners that meet relevant laws and regulations may also be applied to the implementations of the present disclosure.

At the same time, it should be understood that the data involved in the technical solutions (including but not limited to data itself, data acquisition or use) should comply with requirements of corresponding laws, regulations and related provisions.

In the related art, the following problems exist in the displayed charts.

First, the business process nodes with the maximum churn are checked one by one, and the maximum churn rate data is calculated manually, which leads to high cost of insight problem search.

Second, the identification degree of some information in the chart is low, the sense of interaction is weak, and the identification degree of information in different channels is low, which leads to low efficiency of understanding the information in the chart.

Third, the space of the page of the chart is wasted, which results in too few charts corresponding to different channel scenarios displayed on each screen of the electronic device when the chart is too wide, and too much longitudinal space of the screen is occupied when the chart is too long.

Fourth, the lack of basic funnel chart styles leads to insufficient diversity in chart display.

Fifth, adjusting a parameter in the chart requires repeated scrolling of the page, which leads to high operation cost.

In view of this, embodiments of the present disclosure provide an information display method, an apparatus, a medium, an electronic device and a program product to solve the above problems.

The present disclosure will be further explained and illustrated below with reference to the drawings.

FIG. 1 is a flowchart of an information display method according to an exemplary embodiment of the present disclosure. The method may be performed by an information display apparatus, and the apparatus may be implemented by software and/or hardware, and may be configured in an electronic device, typically, may be configured in a mobile phone or a tablet computer. Referring to FIG. 1, the information display method may include the following steps.

Step 110: displaying charts corresponding to different channel scenarios in response to a trigger operation for conversion analysis of a target business in an information display page. The target business includes a plurality of business process nodes, and a chart corresponding to a channel scenario includes a maximum churn rate among all business process nodes in the channel scenario determined based on data corresponding to the channel scenario.

It should be noted that the electronic device may be built-in with a conversion analysis model, and the conversion analysis model may perform big data analysis based on data corresponding to the channel scenario to obtain an analysis result, and construct the chart corresponding to the channel scenario according to the analysis result, and then the electronic device renders the chart for displaying in the information display page.

The channel scenario may be understood as a different manner for implementing the target business, for example, performing the target business by electronic devices of different models, performing the target business by different applications, and so on.

The target business may be a registration business, a sharing business, etc. The target business may include a plurality of business process nodes. For example, taking the registration business as an example, the plurality of business process nodes of the registration business may include “triggering a login pop-up window”, “authorizing to acquire a mobile phone number”, “clicking to agree to a user agreement”, “clicking to log in with one click”, and “registering and successfully logging in”.

For a churn rate of a certain business process node, the churn rate of the business process node is a negative value of a ratio between a number of people exiting the business process node within a period of time and a number of people reaching the business process node from a previous business process node of the business process node within the same period of time.

The chart corresponding to the channel scenario may further include a conversion rate corresponding to each business process node. For a conversion rate of a certain business process node, the conversion rate of the business process node is a ratio between a number of people reaching the business process node from a previous business process node of the business process node within a period of time and a number of people reaching the business process node within the same period of time.

The channel scenario includes a scenario constituted by data corresponding to a single channel and a scenario constituted by data corresponding to all single channels, which meets a user's requirement for comparing a conversion rate of a certain single channel with an entirety that is constructed and obtained from all the single channels. It should be noted that the data corresponding to the channel may include user behavior data, and the conversion analysis may be implemented by analyzing the user behavior data.

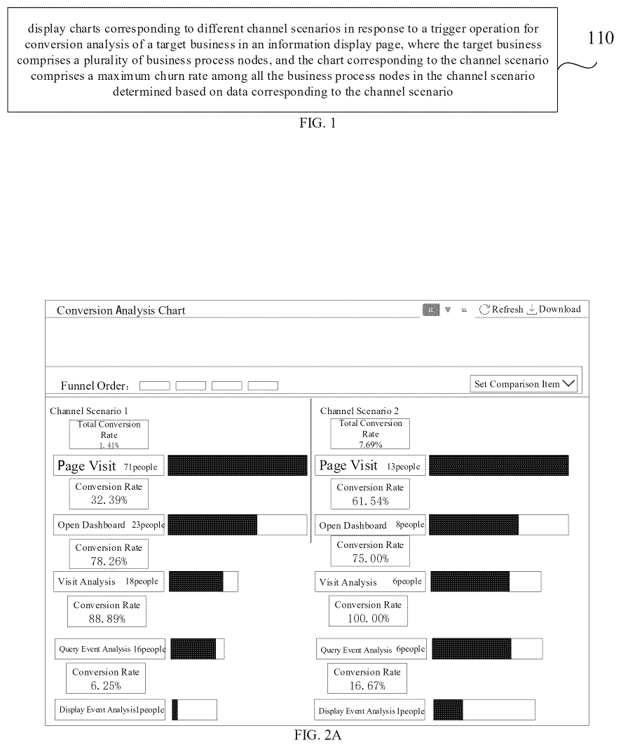

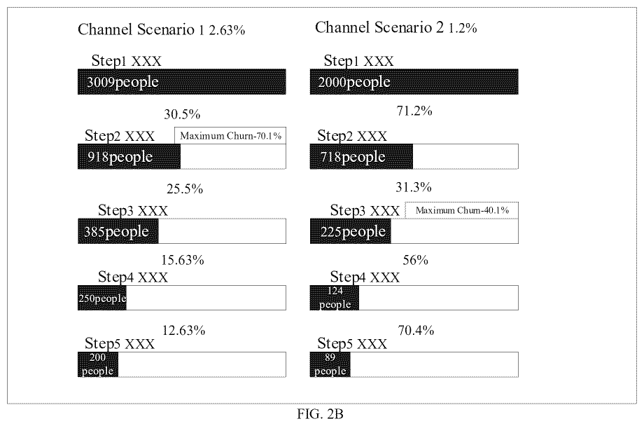

FIG. 2A is a schematic diagram of a chart in the related art, and FIG. 2B is a schematic diagram of a chart according to an exemplary embodiment of the present disclosure. In the chart in FIG. 2A, the maximum churn rate is not displayed, and it is necessary to check information displayed by the business process nodes one by one manually, so as to calculate and obtain the maximum churn rate among all the business process nodes manually. However, in the solution provided by the present disclosure, that is, in the chart in FIG. 2B, the maximum churn rate among all the business process nodes in each channel scenario is intuitively displayed, that is, “maximum churn −70.1%” and “maximum churn −40.1%” displayed in FIG. 2B. It should be noted that the respective steps in FIG. 2B represent different business process nodes, and the respective steps in the following figures have the same physical meaning.

With the above technical solutions, the displayed chart includes the maximum churn rate among all the business process nodes in the channel scenario determined based on the data corresponding to the channel scenario, so that a user can acquire the maximum churn rate from the chart intuitively without checking the business process nodes one by one and calculating the related data to obtain the maximum churn rate manually, thereby improving the efficiency of insight problem search and reducing the cost of insight problem search.

In a possible manner, the information display page includes a chart display region and a non-chart display region, the chart display region is used to display the chart, the non-chart display region includes a comparison component, and the comparison component is used to support a user to configure the channel scenario and a display order of charts corresponding to all channel scenarios in the chart display region.

It should be noted that in the related art, components used to support the user to configure the channel scenarios and a display order of the charts corresponding to the channel scenarios in the chart display region are independent of each other and deployed in the chart display region, which results in a relatively small amount of information displayed in the chart display region at the same time, and requiring the user to scroll the chart continuously to switch the information displayed in the chart display region.

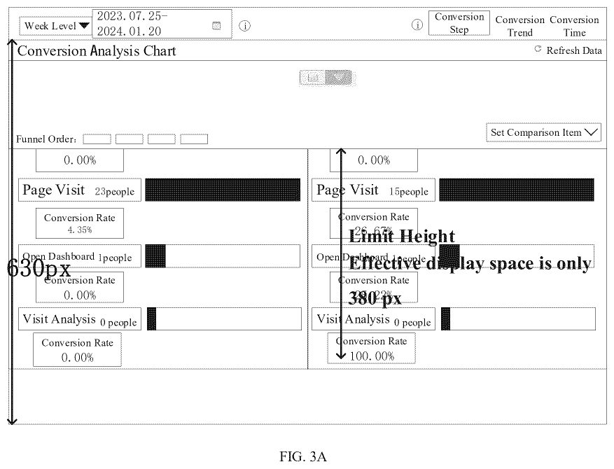

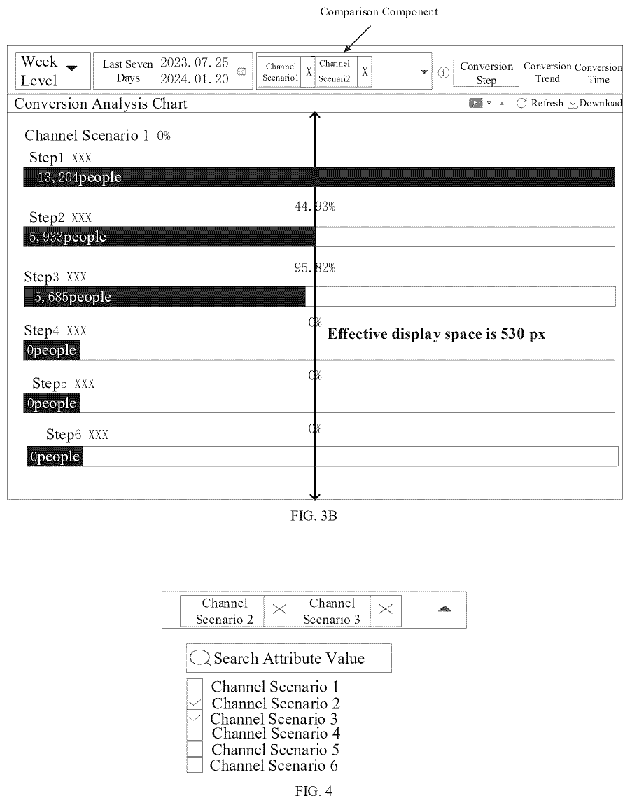

FIG. 3A is a schematic diagram of a chart in the related art, and FIG. 3B is a schematic diagram of a chart according to an exemplary embodiment of the present disclosure. Referring to FIG. 3A, a funnel order displayed in FIG. 3A is a component used to configure the display order of the charts (i.e., conversion analysis charts shown in the figure) corresponding to all the channel scenarios in the chart display region, and setting a comparison item displayed in FIG. 3A is a component used to support the user to configure the channel scenarios, and both the components are disposed in the chart display region. Referring to FIG. 3B, the comparison component is disposed in the non-chart display region. Therefore, in the case that the chart display region corresponding to the chart is divided into 630 px (pixels), an effective display space of the chart in the related art is only 380 px. In the solution of the present disclosure, since the components used to support the user to configure the channel scenarios and the display order of the charts corresponding to all the channel scenarios in the chart display region are disposed outside the chart display region, and the two functions are combined into one comparison component, the space occupied by the components configured to support the user to configure the channel scenarios and the display order of the charts corresponding to all the channel scenarios in the chart display region in the chart display region is avoided, and the display space of the effective information in the chart is increased. For example, as shown in FIG. 3B, the effective display space of the chart is 530 px.

With the above manner, the comparison component used to support the user to configure the channel scenarios and the display order of the charts corresponding to all the channel scenarios in the chart display region is disposed in the chart display region, thereby avoiding occupying the display space of the chart in the chart display region, enabling more information expressed by the chart to be displayed, and increasing the proportion of the effective information in the chart. In addition, the comparison component combines the function used to support the user to configure the channel scenarios and the function of the comparison component used to support the user to configure the display order of the charts corresponding to all the channel scenarios in the chart display region and disposed in the chart display region, thereby further reducing the space occupied by the page.

FIG. 4 is a schematic diagram of a comparison component according to an exemplary embodiment of the present disclosure. The user may click a control indicated by a triangle graphic in the comparison component in FIG. 4 to trigger displaying of an interface diagram for selecting a channel scenario in FIG. 4, and the configuration of the channel scenario may be implemented based on the interface diagram.

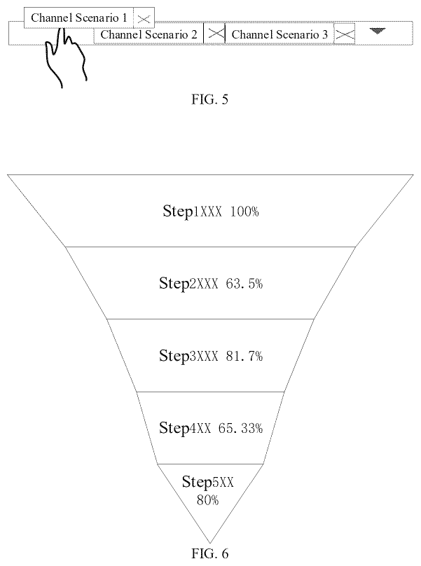

FIG. 5 is a schematic diagram of a comparison component according to an exemplary embodiment of the present disclosure. The user may select the channel scenario 1 and drag the channel scenario 1 to implement adjustment of the order among the channel scenario 1, the channel scenario 2 and the channel scenario 3. The order here is the display order of the charts respectively corresponding to the channel scenario 1, the channel scenario 2 and the channel scenario 3 in the chart display region. Specifically, the display order here may refer to the order of respective charts from left to right.

In some embodiments, the non-chart display region further includes a chart type switching component, and the above step of displaying the chart corresponding to the channel scenario may include: displaying the chart corresponding to the channel scenario in a first display style, where the first display style includes a chart display type determined based on the chart type switching component, and the chart display type includes a bar display type or a funnel graphic display type.

As an example, a form of displaying information in the chart in the bar display type may refer to FIG. 3B, in which conversion results of different business process nodes are displayed through bar-shaped graphics.

As an example, FIG. 6 is a schematic diagram of displaying conversion results of respective business process nodes in a chart displayed in a funnel graphic display type according to an exemplary embodiment of the present disclosure.

Compared with the related art, with the above manner, the chart type switching component is disposed in the non-chart display region, thereby further avoiding occupying the display space of the chart in the chart display region, enabling more information expressed by the chart to be displayed, and increasing the proportion of the effective information in the chart. In addition, the funnel graphic display type is added, which increases the diversity of chart display.

In some embodiments, the first display style further includes a color style that distinguishes the different channel scenarios. It should be noted that such color style refers to different colors.

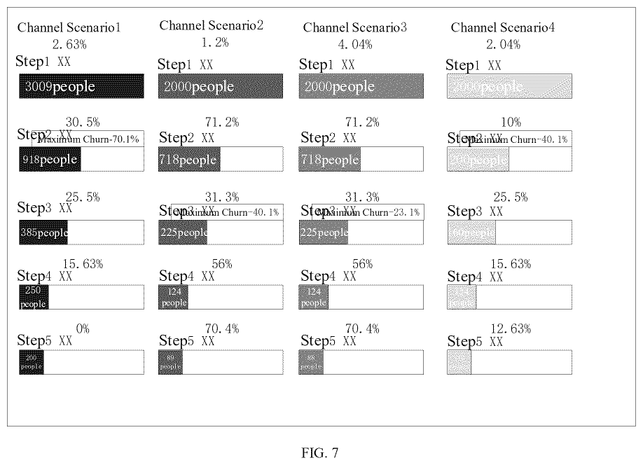

FIG. 7 is a schematic diagram of charts corresponding to different channel scenarios displayed in different color styles according to an exemplary embodiment of the present disclosure. In FIG. 7, different gray levels represent different colors. It should be noted that because text in the page needs to be clearly displayed, and the display width of the page of the present disclosure is limited, which results in the overlap between the maximum churn and the name of the business process node. However, in practical applications, the maximum churn rate will not cover the name corresponding to the business process node. That is, in practical applications, the font size of each text may be set reasonably so that the data is displayed reasonably.

With the above manner, the data of the charts corresponding to different channel scenarios is displayed in different colors, which can improve the identification degree of each channel scenario and assist the user to quickly distinguish the data of the charts of different channel scenarios.

In some embodiments, when the chart is displayed in the bar display type, the above step of displaying the chart corresponding to the channel scenario may further include: displaying a bar-shaped graphic corresponding to each of the business process nodes in the chart in a second display style, where the bar-shaped graphic displayed in the second display style is used to describe a comparison between a conversion amount and a churn amount corresponding to the business process node, and the second display style includes a style for displaying the churn amount in a preset style.

It should be noted that displaying the bar-shaped graphic corresponding to each of the business process nodes in the chart in the second display style enables the chart to describe the comparison between the conversion amount and the churn amount corresponding to the business process node.

As an example, the second display style further includes a style for displaying the churn amount in the preset style, and this style can enable the user to quickly identify the churn data. For example, the preset style may be to fill the bar-shaped graphic corresponding to the churn amount in a manner of colored oblique lines, and the colored oblique lines here may be solid lines or dotted lines, etc.

As an example, the second display style further includes a style for displaying the conversion amount in a preset color.

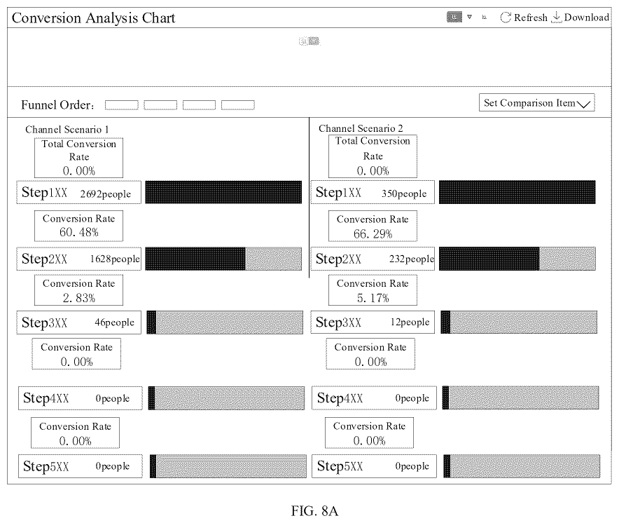

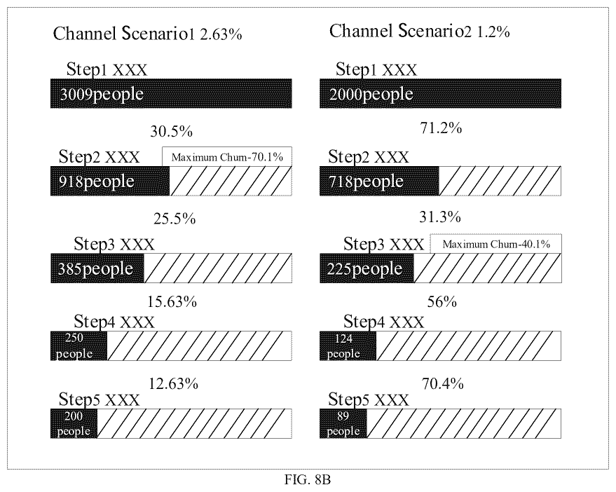

FIG. 8A is a schematic diagram of a chart in the related art. FIG. 8B is a schematic diagram of a chart according to an exemplary embodiment of the present disclosure. In FIG. 8A, the churn amount and the conversion amount in the chart are only distinguished by using different colors, and the churn amount is usually displayed in gray. However, in FIG. 8B, the bar-shaped graphic corresponding to the churn amount is filled in a manner of colored oblique lines.

Compared with the related art, with the above manner, the solution displays the style of the churn amount in the preset style, which can improve the identification degree and the sense of interaction when the user browses the churn data.

In some embodiments, the chart further includes a name corresponding to each of the business process nodes, and one of the name corresponding to the business process node and the bar-shaped graphic is located above the other of the name corresponding to the business process node and the bar-shaped graphic.

Continuing to refer to FIG. 2A, in FIG. 2A, the name corresponding to the business process node (i.e., page visit, open dashboard, etc. shown in FIG. 2A) and the bar-shaped graphic are displayed side by side, and this manner requires a relatively large width of the information display page to be occupied, which results in a limited number of channel scenarios that can be displayed, and requiring the user to continuously operate the screen to switch and display the charts corresponding to other channel scenarios. With reference to the chart shown in FIG. 7, the names corresponding to the business process nodes (i.e., step 1XX, step 2XX, etc. shown in FIG. 7) are displayed above the bar-shaped graphics, thereby reducing the width occupied by the name and the bar-shaped graphic on the information display page, so that more charts corresponding to the channel scenarios can be displayed.

Compared with the related art, with the above manner, the width occupied by part of data in the chart is reduced, and the number of displayed channel scenarios is increased, so that the user can pay attention to more effective information in the chart at the same time.

In some embodiments, the chart further includes information on a number of converted people, and the information on the number of converted people is displayed in the bar-shaped graphic.

Continuing to refer to FIG. 2A, in the related art, the bar-shaped graphic and the information on the number of converted people are separated, which requires more space on the page to be occupied. Continuing to refer to FIG. 7, the information on the number of converted people is displayed in the bar-shaped graphic, thereby reducing the space occupied by the bar-shaped graphic and the information on the number of converted people on the page.

In some embodiments, the chart further includes a name corresponding to the channel scenario and a total conversion rate of the target business in the channel scenario, and the name corresponding to the channel scenario and the total conversion rate are displayed in the chart side by side.

It should be noted that the total conversion rate of the target business in the channel scenario is determined based on data corresponding to the channel scenario, and the total conversion rate of the target business in the channel scenario is a ratio of a number of people who successfully complete the target business to a number of people who trigger the target business in the same period of time. For example, taking a login business as an example, within a certain period of time, the number of people who have successfully logged in is 5, and the number of people who trigger the login within the period of time is 100, then the total conversion rate of the login business is 5%.

In other examples, the display of the name corresponding to the channel scenario and the total conversion rate may be enhanced. For example, the font size of the name corresponding to the channel scenario and the total conversion rate is increased.

Continuing to refer to FIG. 7, the channel scenario 1 (i.e., the example name of the business process node) and the total conversion rate of 2.63% corresponding to the channel scenario 1 are displayed side by side. With the above manner, based on the user's reading movement line from left to right, the name corresponding to the channel scenario and the total conversion rate of 2.63% corresponding to the channel scenario 1 are placed side by side. In practical applications, a bold text style may be used to highlight the name corresponding to the channel scenario 1 and the total conversion rate, so that the user can quickly know the total conversion rates of different channel scenarios.

In some embodiments, the above method may further include: updating and displaying names corresponding to all first business process nodes in the chart in response to a modification operation for the name corresponding to the first business process node in the chart display region.

The business process node whose name needs to be modified is the first business process node, and the business process node whose name needs to be modified is selected by the user. The first business process node may be any one of all the business process nodes in any channel scenario displayed in the chart.

The user may hover the mouse over an area in the chart display region where the name corresponding to the business process node whose name needs to be modified is located, so that a control for performing the modification operation may be triggered. Specifically, the control may include an edit operation control and a save operation control. The user clicks the edit operation control, so that the name corresponding to the first business process node can be modified. After the editing is completed, the user clicks the save operation control, so that the modification operation for the name corresponding to the first business process node is triggered.

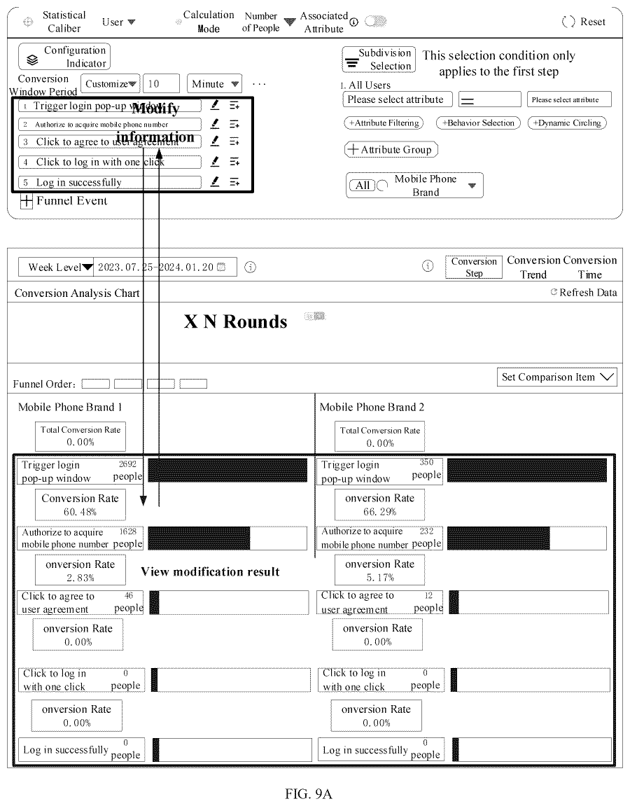

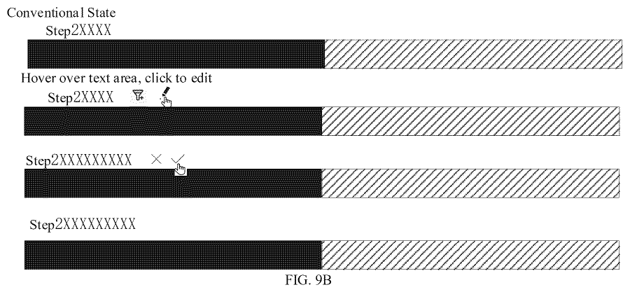

FIG. 9A is a schematic diagram of a chart in the related art. Referring to FIG. 9A, when the user changes the name corresponding to the first business process node, the user needs to switch to the non-chart display region. Specifically, the user needs to locate a rectangular box corresponding to modification information marked in FIG. 9A, and view the modification result in the chart display region.

FIG. 9B is a schematic diagram of a process of modifying a name of a certain business process node in a chart of a certain channel scenario displayed in a chart display region. Referring to FIG. 9B, in the chart, when the mouse of the user hovers over a text area corresponding to the name of the business process node (step 2XXXX), the edit operation control may be displayed. The user clicks the edit operation control, and then the user may start editing the text, and the save operation control is displayed. After the editing is completed, the user may click the save operation control (i.e., “√” shown in FIG. 9B), so as to trigger the modification operation for the name corresponding to the business process node, and “step 2XXXXXXXXX” after modification is displayed.

It should be noted that when the user triggers the modification operation for a name corresponding to a certain business process node in a certain channel scenario, the modification operation for the names corresponding to the business process nodes in other channel scenarios that are the same as the name corresponding to the business process node in the certain channel scenario may be triggered synchronously, which is convenient for the user to perform comparative analysis for different channel scenarios under the same conditions. For example, taking FIG. 8B as an example, when the user triggers the modification operation for “step 2XX” in the channel scenario 1, the modification operation for “step 2XX” in the channel scenario 2 is triggered synchronously.

Compared with the related art, with the above technical solutions, an interactive manner of modifying the name of the business process node directly on the chart is configured, which meets the user's requirement for conveniently adjusting the parameter and viewing the chart result in a real-time analysis scenario, so that the user experience is improved.

In some embodiments, the above method may further include: updating and displaying the chart corresponding to all the channel scenarios in the chart in response to an adjustment operation for an order of second business process nodes in the chart display region.

The second business process node is selected by the user. The second business process node may be any one of all the business process nodes in any channel scenario displayed in the chart.

It should be noted that when the user triggers an adjustment operation for a certain business process node in a certain channel scenario, the adjustment operation for names of business process nodes in other channel scenarios that are the same as the name corresponding to the business process node in the certain channel scenario may be triggered synchronously, which is convenient for the user to perform comparative analysis for different channel scenarios under the same conditions. For example, taking FIG. 8B as an example, when the user triggers the adjustment operation for the order of “step 2XXX” in the channel scenario 1, the adjustment operation for the order of “step 2XXX” in the channel scenario 2 is triggered synchronously.

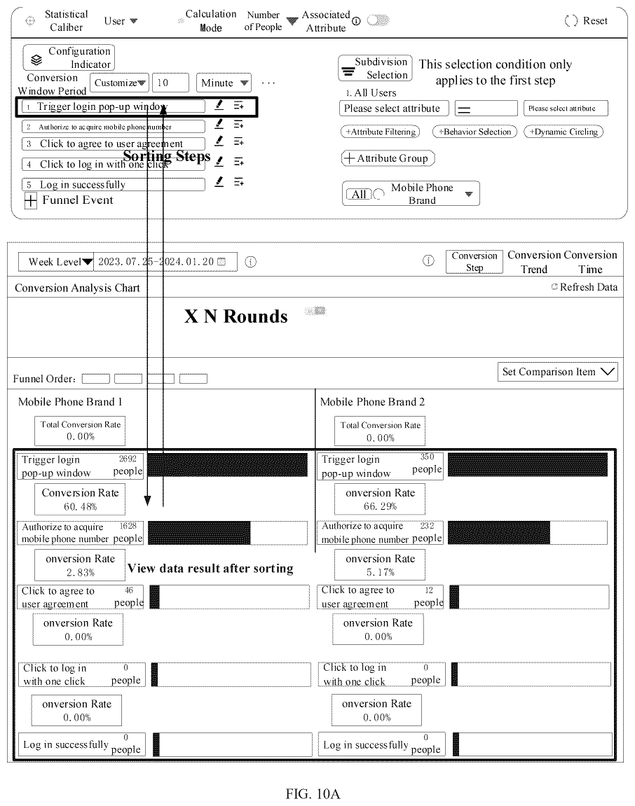

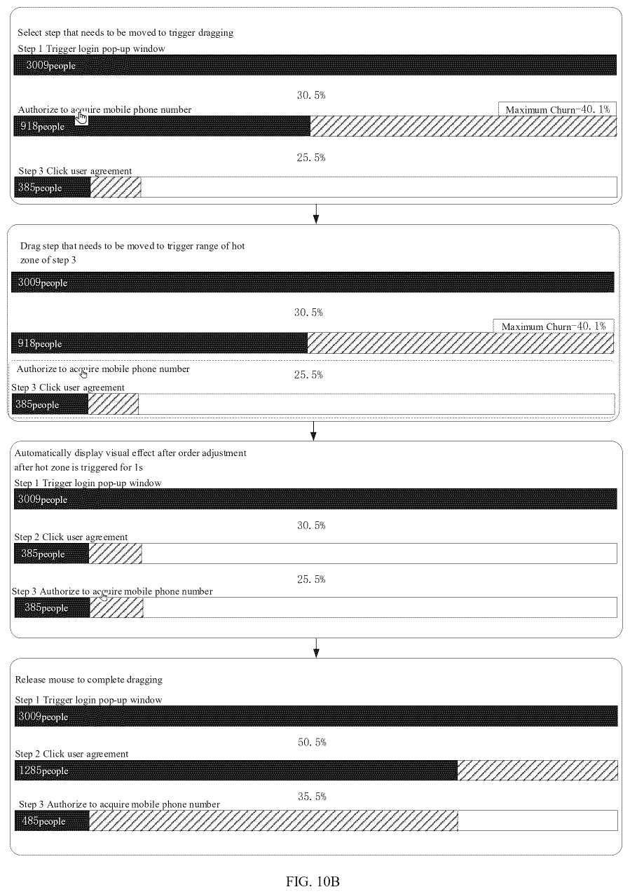

FIG. 10A is a schematic diagram of a chart in the related art. Referring to FIG. 10A, when the user adjusts the order of each business process node, the user needs to switch to the non-chart display region (a region where the configuration indicator is located). Specifically, the user needs to locate a rectangular box corresponding to sorting steps marked in FIG. 9A, and view the modification result in the chart display region.

FIG. 10B is a schematic diagram of a process of adjusting sorting among a plurality of business process nodes in a chart of a certain channel scenario displayed in a chart display region. The user may select a step that needs to be moved, “authorizing to acquire a mobile phone number” (i.e., the second business process node) to trigger dragging, and drag it to a range of a hot zone that triggers step 3 (a dotted line box shown in FIG. 10B). After the hot zone is triggered for 1 s, a visual effect after the order is adjusted is automatically displayed, and after the user releases the mouse, the dragging is completed, that is, the adjustment operation is triggered, and the charts corresponding to all the channel scenarios in the chart are updated and displayed.

It should be noted that after the order corresponding to the plurality of business process nodes is adjusted, the data in the chart will also be changed accordingly, so that the entire chart needs to be updated.

Compared with the related art, with the above technical solutions, an interactive manner of modifying the order of the business process node directly on the chart is configured, which meets the user's requirement for conveniently adjusting the parameter and viewing the chart result in a real-time analysis scenario, so that the user experience is improved.

In some embodiments, the above method may further include: updating and displaying a chart corresponding to all the channel scenarios in the chart in response to a delete operation for a third target business process node in the chart display region.

The third business process node may be selected by the user. The third business process node may be any one of all the business process nodes in any channel scenario displayed in the chart.

It should be noted that when the user triggers a delete operation for a certain business process node in a certain channel scenario, the delete operation for the names of the business process nodes in other channel scenarios that are the same as the name corresponding to the business process node in the certain channel scenario may be triggered synchronously, which is convenient for the user to perform comparative analysis for different channel scenarios under the same conditions. For example, taking FIG. 8B as an example, when the user triggers the delete operation for “step 2XXX” in the channel scenario 1, the delete operation for “step 2XXX” in the channel scenario 2 is triggered synchronously.

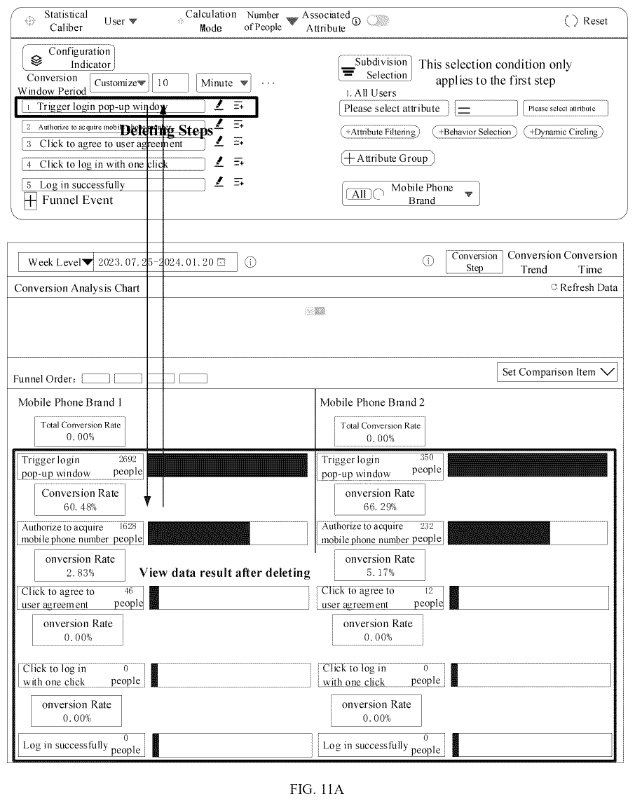

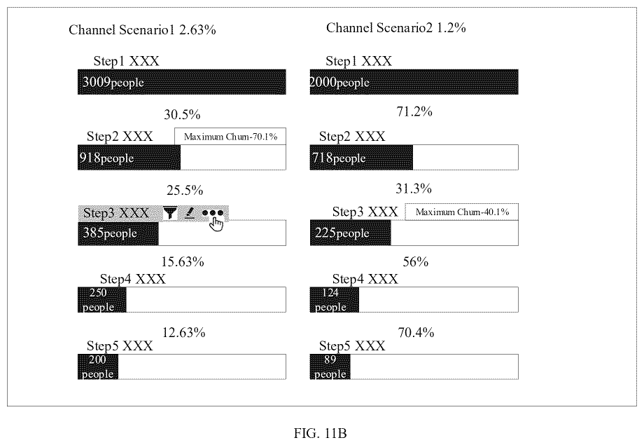

FIG. 11A is a schematic diagram of a chart in the related art. Referring to FIG. 11A, when the user deletes a certain business process node, the user needs to switch to the non-chart display region. Specifically, the user needs to locate a rectangular box corresponding to deleting steps marked in FIG. 11A, and view the modification result in the chart display region.

FIG. 11B is a schematic diagram of deleting a certain business process node in a chart of a certain channel scenario displayed in a chart display region. Referring to FIG. 11B, in the chart, when the mouse of the user hovers over a text area (step 3XXX), a delete control for the business process node may be displayed. The user clicks the delete control to trigger the delete operation for the business process node, and “step 3XXX” no longer appears in the updated and displayed chart.

It should be noted that after a certain business process node is deleted, the data in the chart will also be changed accordingly, so that the entire chart needs to be updated.

Compared with the related art, with the above technical solutions, an interactive manner of deleting the business process node directly on the chart is configured, which meets the user's requirement for conveniently adjusting the parameter and viewing the chart result in a real-time analysis scenario, so that the user experience is improved.

In some embodiments, the above method may further include: updating and displaying the chart corresponding to all the channel scenarios in the chart in response to a filter operation for a fourth target business process node in the chart display region.

The fourth target business process node is any one or more of the business process nodes, the filter operation is used to support the user to configure a filter condition for the fourth target business process node, and data for determining the churn rate is different under different filter conditions.

It should be noted that when the user triggers the filter operation for a certain business process node in a certain channel scenario, the filter operation for the business process nodes in other channel scenarios whose names are the same as the name corresponding to the business process node in the certain channel scenario may be triggered synchronously, which is convenient for the user to perform comparative analysis for different channel scenarios under the same conditions. For example, taking FIG. 8B as an example, when the user triggers the filter operation for “step 2XXX” in the channel scenario 1, the filter operation for “step 2XXX” in the channel scenario 2 is triggered synchronously.

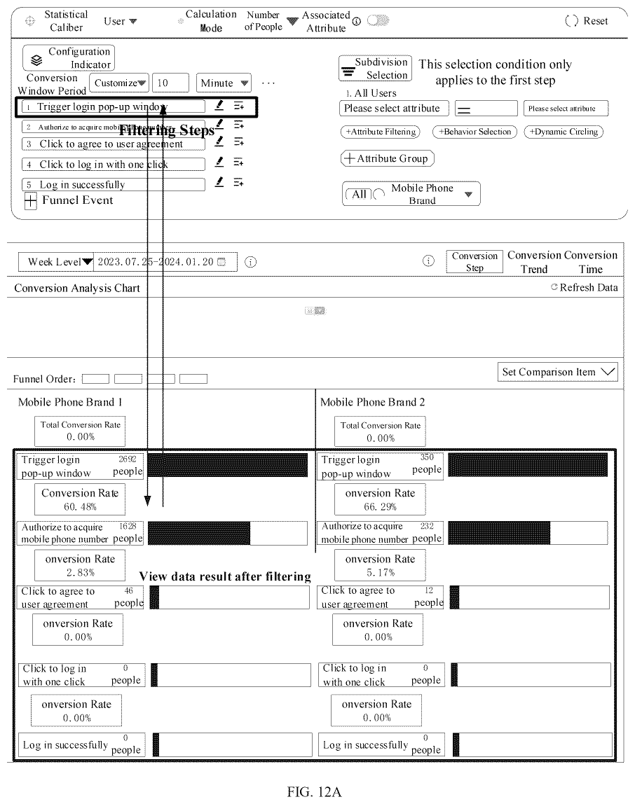

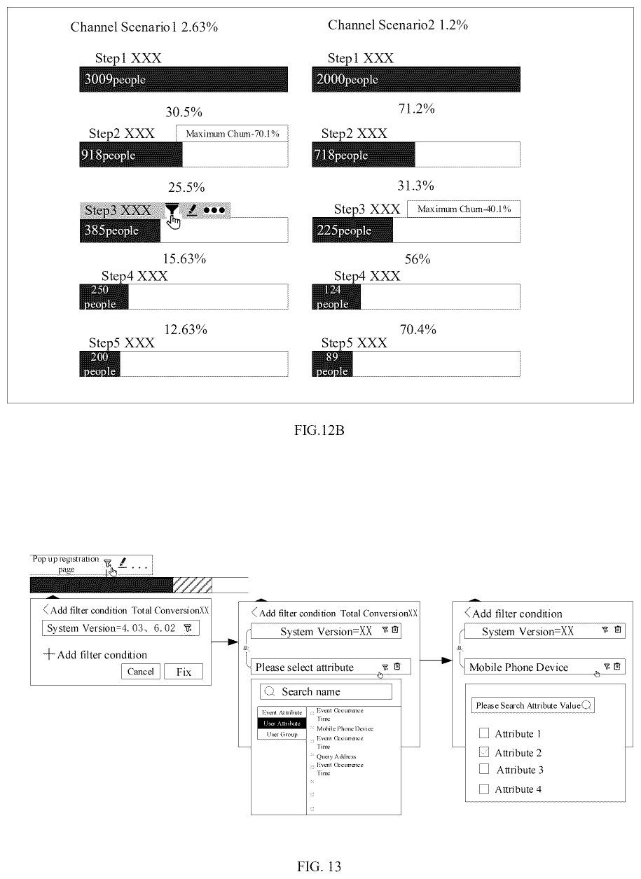

FIG. 12A is a schematic diagram of a chart in the related art. Referring to FIG. 12A, when the user configures the filter condition for the business process node, the user needs to switch to the non-chart display region. Specifically, the user needs to locate a rectangular box corresponding to filtering steps marked in FIG. 12A, and view the modification result in the chart display region.

FIG. 12B is a schematic diagram of triggering configuration of a filter condition for a business process node in the business process node in a certain chart displayed in the display region. Referring to FIG. 12B, in the chart, when the mouse of the user hovers over a text area (step 3XXX), a filter control is displayed. If the filter control is clicked, an interface for triggering displaying of the configuration of the filter condition for the business process node may be displayed. The user implements the configuration of the filter condition based on the interface, and triggers the filter operation for the business process node.

FIG. 13 is a schematic diagram of a process of configuring a filter condition for a business process node in the business process node according to an exemplary embodiment of the present disclosure. Referring to FIG. 13, the user may configure attributes of a mobile phone device, a system version, a time when an event occurred, etc., to implement the configuration of the filter condition, thereby changing the data used to determine the conversion rate and the churn rate.

It should be noted that after the filter condition for a certain business process node is changed, the data in the chart will also be changed accordingly, so that the entire chart needs to be updated.

Compared with the related art, with the above technical solutions, an interactive manner of configuring the filter condition directly on the chart is configured, which meets the user's requirement for conveniently adjusting the parameter and viewing the chart result in a real-time analysis scenario, so that the user experience is improved.

In some embodiments, the above method may further include: deleting a chart corresponding to a first target channel scenario from the chart display region in response to a delete operation for the first target channel scenario in the chart display region.

The first target channel scenario may be any one of all the channel scenarios in the chart before the response to the delete operation, and the first target channel scenario may be selected by the user.

Continuing to refer to FIG. 2A, in the related art, the user needs to implement the deletion of the first target channel scenario through “setting a comparison item”.

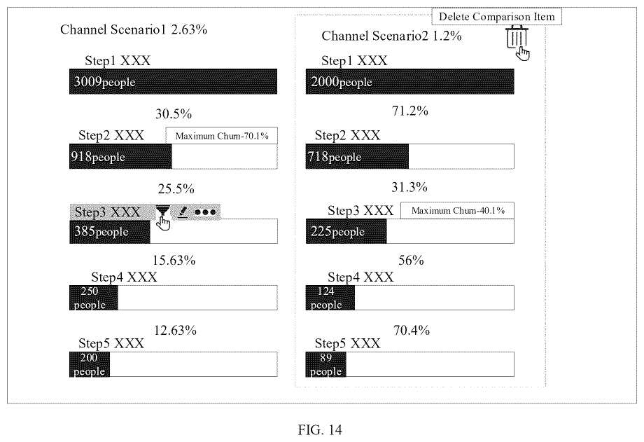

FIG. 14 is a schematic diagram of deleting a first target channel scenario according to an exemplary embodiment of the present disclosure. Referring to FIG. 14, the user may control the mouse to hover over the delete control, and then a prompt message “deleting a comparison item” is displayed. Further, the user may click the delete control to trigger the delete operation for the first target channel scenario.

Compared with the related art, with the above manner, the quick deletion of the chart corresponding to the channel scenario can be implemented.

In some embodiments, if the channel scenario includes a scenario constructed in a case where the channel scenario is constructed from all the single channels, when a chart corresponding to a certain single channel is deleted, the chart corresponding to the channel scenario constructed from all the single channels needs to be updated.

In some embodiments, the above method may further include: adding and displaying a chart corresponding to a second target channel scenario in the chart display region in response to an addition operation for the second target channel scenario in the chart display region.

The second target channel scenario is a channel scenario different from all channel scenarios in the chart before the response to the delete operation.

Continuing to refer to FIG. 2A, in the related art, the addition of the channel scenario needs to be implemented through “set comparison item”.

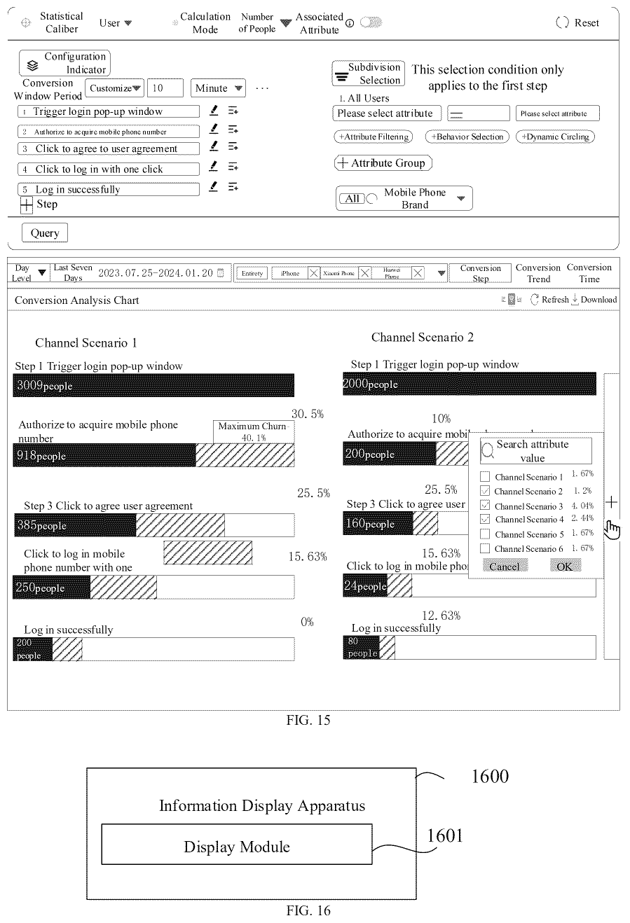

FIG. 15 is a schematic diagram of adding a second target channel scenario according to an exemplary embodiment of the present disclosure. Referring to FIG. 15, the user may click an addition control “+” in the chart to display respective channel scenarios, select the second target channel scenario to be added, and click an “OK” control shown in FIG. 15 to trigger the addition operation for the second target channel scenario.

Compared with the related art, with the above manner, the quick addition of the chart corresponding to the channel scenario can be implemented, which meets the user's intuitive operation requirement when the user needs to continue to add the channel scenario.

In some embodiments, if the channel scenario includes a scenario constructed in a case where the channel scenario is constructed from all the single channels, when a chart corresponding to a certain single channel is added, the chart corresponding to the channel scenario constructed from all the single channels needs to be updated.

It should be noted that the present disclosure adds interactive manners in the chart to the existing technical solutions, such as the above addition operation, delete operation and filter operation, etc. In the non-chart display region, for example, a region for configuring an event shown in FIG. 15, interactive operations with the same functions are still supported.

FIG. 16 is a block diagram of an information display apparatus according to an exemplary embodiment of the present disclosure. Referring to FIG. 16, the information display apparatus includes:
a display module 1601 configured to display charts corresponding to different channel scenarios in response to a trigger operation for conversion analysis of a target business in an information display page;
where the target business includes a plurality of business process nodes, and a chart corresponding to a channel scenario includes a maximum churn rate among all business process nodes in the channel scenario determined based on data corresponding to the channel scenario.

Optionally, the information display page includes a chart display region and a non-chart display region, the chart display region is used to display the chart, the non-chart display region includes a comparison component, and the comparison component is used to support a user to configure the channel scenario and a display order of charts corresponding to all channel scenarios in the chart display region.

Optionally, the non-chart display region further includes a chart type switching component, and the display module is specifically configured to: display the chart corresponding to the channel scenario in a first display style, where the first display style includes a chart display type determined based on the chart type switching component, and the chart display type includes a bar display type or a funnel graphic display type.

Optionally, the first display style further includes a color style that distinguishes the different channel scenarios.

Optionally, the display module 1601 is specifically configured to: when the chart is displayed in the bar display type, display a bar-shaped graphic corresponding to each of the business process nodes in the chart in a second display style, where the bar-shaped graphic displayed in the second display style is used to describe a comparison between a conversion amount and a churn amount corresponding to the business process node, and the second display style further includes a style for displaying the churn amount in a preset style.

Optionally, the chart further includes a name corresponding to each of the business process nodes, and one of the name corresponding to the business process node and the bar-shaped graphic is located above the other of the name corresponding to the business process node and the bar-shaped graphic.

Optionally, the chart further includes information on a number of converted people, and the information on the number of converted people is displayed in the bar-shaped graphic.

Optionally, the chart further includes a name corresponding to the channel scenario and a total conversion rate of the target business in the channel scenario, and the name corresponding to the channel scenario and the total conversion rate are displayed in the chart side by side.

Optionally, the channel scenario includes a scenario constituted by data corresponding to a single channel and a scenario constituted by data corresponding to all single channels.

Optionally, the information display page includes a chart display region for displaying the chart, the chart further includes a name corresponding to each of the business process nodes, and the information display apparatus 1600 further includes:
a first response module configured to update and display names corresponding to all first business process nodes in the chart in response to a modification operation for the name corresponding to the first business process node in the chart display region.

Optionally, the information display page includes a chart display region for displaying the chart, and the information display apparatus 1600 further includes:
a second response module configured to update and display the chart corresponding to all the channel scenarios in the chart in response to an adjustment operation for an order of a second business process node in the chart display region.

Optionally, the information display page includes a chart display region for displaying the chart, and the information display apparatus 1600 further includes:
a second response module configured to update and display the chart corresponding to all the channel scenarios in the chart in response to a delete operation for a third target business process node in the chart display region.

Optionally, the information display page includes a chart display region for displaying the chart, and the information display apparatus 1600 further includes:
a third response module configured to update and display the chart corresponding to all the channel scenarios in the chart in response to a filter operation for a fourth target business process node in the chart display region. The filter operation is used to support a user to configure a filter condition for a second target business process node, and data for determining a churn rate is different under different filter conditions.

Optionally, the information display page includes a chart display region for displaying the chart, and the information display apparatus 1600 further includes:
a fourth response module configured to delete a chart corresponding to a first target channel scenario from the chart display region in response to a delete operation for the first target channel scenario in the chart display region.

Optionally, the information display page includes a chart display region for displaying the chart, and the information display apparatus 1600 further includes:
a fifth response module configured to add and display a chart corresponding to a second target channel scenario in the chart display region in response to an addition operation for the second target channel scenario in the chart display region. The second target channel scenario is a channel scenario different from all channel scenarios in the chart before a response to a delete operation.

For the implementation of each module in the above information display apparatus 1600, reference may be made to the above related embodiments, which will not be repeated in this embodiment.

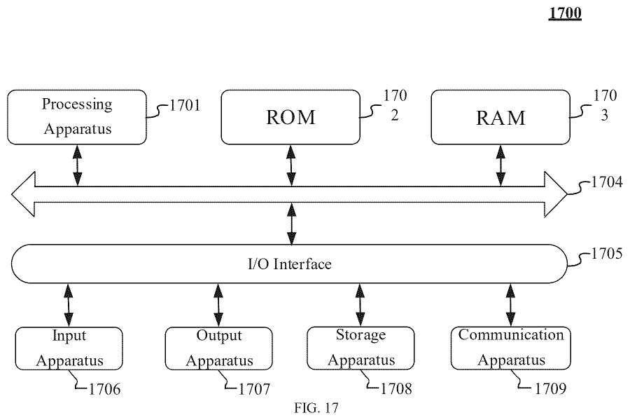

Reference is made to FIG. 17 below, which illustrates a schematic structural diagram of an electronic device 1700 suitable for implementing the embodiments of the present disclosure. The terminal devices in the embodiments of the present disclosure may include, but are not limited to, mobile terminals such as mobile phones, notebook computers, digital broadcast receivers, PDAs (personal digital assistants), PADs (tablet computers), PMPs (portable multimedia players), vehicle-mounted terminals (such as vehicle-mounted navigation terminals), and fixed terminals such as digital TVs, desktop computers, etc. The electronic device shown in FIG. 17 is only an example, and should not impose any limitation on the functions and scope of use of the embodiments of the present disclosure.

As shown in FIG. 17, the electronic device 1700 may include a processing apparatus (such as a central processing unit, a graphics processing unit, etc.) 1701, which may perform various appropriate actions and processes according to a program stored in a read-only memory (ROM) 1702 or a program loaded from a storage apparatus 1708 into a random access memory (RAM) 1703. Various programs and data required for the operation of the electronic device 1700 are also stored in the RAM 1703. The processing apparatus 1701, ROM 1702, and RAM 1703 are connected to each other through a bus 1704. An input/output (I/O) interface 1705 is also connected to the bus 1704.

Generally, the following apparatuses may be connected to the I/O interface 1705: an input apparatus 1706 including, for example, a touchscreen, a touchpad, a keyboard, a mouse, a camera, a microphone, an accelerometer, a gyroscope, etc.; an output apparatus 1707 including, for example, a liquid crystal display (LCD), a speaker, a vibrator, etc.; a storage apparatus 1708 including, for example, a magnetic tape, a hard disk, etc.; and a communication apparatus 1709. The communication apparatus 1709 may allow the electronic device 1700 to perform wireless or wired communication with other devices to exchange data. While FIG. 17 shows the electronic device 1700 with various apparatuses, it should be understood that not all of the illustrated apparatuses are required to be implemented or provided. More or fewer apparatuses may alternatively be implemented or provided.

In particular, according to an embodiment of the present disclosure, the process described above with reference to the flowchart is implemented as a computer software program. For example, an embodiment of the present disclosure includes a computer program product, which includes a computer program carried on a non-transitory computer-readable medium, and the computer program includes program code for executing the method shown in the flowchart. In such an embodiment, the computer program may be downloaded and installed from a network through the communication apparatus 1709, or installed from the storage apparatus 1708, or installed from the ROM 1702. When the computer program is executed by the processing apparatus 1701, the above functions defined in the methods of the embodiments of the present disclosure are performed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier, in which computer-readable program code is carried. This propagated data signal may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate or transmit a program used by or in combination with an instruction execution system, apparatus or device. The program code contained on the computer-readable medium may be transmitted by any suitable medium, including but not limited to: wire, optical cable, RF (radio frequency), etc., or any suitable combination thereof.

In some implementations, the electronic device may communicate using any currently known or future-developed network protocol, such as HTTP (HyperText Transfer Protocol), and may be interconnected with digital data communication (e.g., communication network) in any form or medium. Examples of communication networks include local area networks (“LAN”), wide area networks (“WAN”), international network (e.g., the Internet), and end-to-end networks (e.g., ad hoc end-to-end networks), as well as any currently known or future-developed networks.

The above computer-readable medium may be included in the above electronic device, or may exist alone without being assembled into the electronic device.

The above computer-readable medium carries one or more programs, and when the above one or more programs are executed by the electronic device, the electronic device is caused to: display charts corresponding to different channel scenarios in response to a trigger operation for conversion analysis of a target business in an information display page; where the target business includes a plurality of business process nodes, and a chart corresponding to a channel scenario includes a maximum churn rate among all business process nodes in the channel scenario determined based on data corresponding to the channel scenario.

The computer program codes for performing the operations of the present disclosure may be written in one or more programming languages or a combination thereof. The above programming languages include but are not limited to object-oriented programming languages such as Java, Smalltalk, C++, and also include conventional procedural programming languages such as “C” language or similar programming languages. The program code may be executed entirely on the user's computer, partly on the user's computer, as a stand-alone software package, partly on the user's computer and partly on a remote computer, or entirely on the remote computer or server. In the case involving the remote computer, the remote computer may be connected to the user's computer through any kind of network, including a local area network (LAN) or a wide area network (WAN), or may be connected to an external computer (for example, via the Internet through an Internet service provider).

The flowcharts and block diagrams in the drawings illustrate the architecture, functions and operations of possible implementations of systems, methods and computer program products according to various embodiments of the present disclosure. In this point, each block in the flowcharts or block diagrams may represent a module, a program segment, or a part of code, which includes one or more executable instructions for implementing a designated logical function. It should also be noted that in some alternative implementations, the functions marked in the blocks may also occur in a different order than the order marked in the drawings. For example, two blocks shown in succession may actually be executed substantially in parallel, and they may sometimes be executed in the reverse order, depending on the functions involved. It should also be noted that each block in the block diagrams and/or flowcharts and the combinations of blocks in the block diagrams and/or flowcharts may be implemented by a dedicated hardware-based system that performs designated functions or operations, or may be implemented by a combination of dedicated hardware and computer instructions.

The modules involved in the embodiments of the present disclosure may be implemented in software or hardware. The name of the module does not constitute a limitation on the module itself under certain circumstances.

The functions described herein above may be performed, at least in part, by one or more hardware logic components. For example, without limitation, exemplary types of hardware logic components that can be used include: field programmable gate array (FPGA), application specific integrated circuit (ASIC), application specific standard product (ASSP), system on chip (SOC), complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalents without departing from the above disclosed concept, for example, a technical solution formed by replacing the above features with technical features with similar functions disclosed in the present disclosure (but not limited to).

In addition, although operations are depicted in a particular order, this should not be understood as requiring these operations to be performed in the particular order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable subcombination.

Although the subject matter has been described in language specific to structural features and/or logical actions of the method, it should be understood that the subject matter defined in the appended claims is not necessarily limited to the specific features or actions described above. Rather, the specific features and actions described above are merely exemplary forms for implementing the claims. With regard to the apparatus in the above embodiments, the specific manner in which each module performs operations has been described in detail in the embodiments relating to the method, and will not be elaborated here.

1. A method for information display, comprising:
displaying charts corresponding to different channel scenarios in response to a trigger operation for conversion analysis of a target business in an information display page,
wherein the target business comprises a plurality of business process nodes, and a chart corresponding to a channel scenario comprises a maximum churn rate among all business process nodes in the channel scenario determined based on data corresponding to the channel scenario.

2. The method of claim 1, wherein the information display page comprises a chart display region and a non-chart display region, the chart display region is used to display the chart, the non-chart display region comprises a comparison component, and the comparison component is used to support a user to configure the channel scenario and a display order of charts corresponding to all channel scenarios in the chart display region.

3. The method of claim 1, wherein the non-chart display region further comprises a chart type switching component, and the displaying the chart corresponding to the channel scenario comprises:
displaying the chart corresponding to the channel scenario in a first display style, wherein the first display style comprises a chart display type determined based on the chart type switching component, and the chart display type comprises a bar display type or a funnel graphic display type.

4. The method of claim 3, wherein the first display style further comprises a color style that distinguishes the different channel scenarios.

5. The method of claim 3, wherein when the chart is displayed in the bar display type, the displaying the chart corresponding to the channel scenario further comprises:
displaying a bar-shaped graphic corresponding to each of the business process nodes in the chart in a second display style, wherein the bar-shaped graphic displayed in the second display style is used to describe a comparison between a conversion amount and a churn amount corresponding to the business process node, and the second display style further comprises a style for displaying the churn amount in a preset style.

6. The method of claim 5, wherein the chart further comprises a name corresponding to each of the business process nodes, and one of the name corresponding to the business process node and the bar-shaped graphic is located above the other of the name corresponding to the business process node and the bar-shaped graphic.

7. The method of claim 5, wherein the chart further comprises information on a number of converted people, and the information on the number of converted people is displayed in the bar-shaped graphic.

8. The method of claim 5, wherein the chart further comprises a name corresponding to the channel scenario and a total conversion rate of the target business in the channel scenario, and the name corresponding to the channel scenario and the total conversion rate are displayed in the chart side by side.

9. The method of claim 1, wherein the channel scenario comprises a scenario constituted by data corresponding to a single channel and a scenario constituted by data corresponding to all single channels.

10. The method of claim 1, wherein the information display page comprises a chart display region for displaying the chart, the chart further comprises a name corresponding to each of the business process nodes, and the method further comprises:
updating and displaying names corresponding to all first business process nodes in the chart in response to a modification operation for the name corresponding to the first business process node in the chart display region.

11. The method of claim 1, wherein the information display page comprises a chart display region for displaying the chart, and the method further comprises:
updating and displaying the chart corresponding to all the channel scenarios in the chart in response to an adjustment operation for an order of a second business process node in the chart display region.

12. The method of claim 1, wherein the information display page comprises a chart display region for displaying the chart, and the method further comprises:
updating and displaying the chart corresponding to all the channel scenarios in the chart in response to a delete operation for a third target business process node in the chart display region.

13. The method of claim 1, wherein the information display page comprises a chart display region for displaying the chart, and the method further comprises:
updating and displaying the chart corresponding to all the channel scenarios in the chart in response to a filter operation for a fourth target business process node in the chart display region, wherein the filter operation is used to support a user to configure a filter condition for a second target business process node, and data for determining a churn rate is different under different filter conditions.

14. The method of claim 1, wherein the information display page comprises a chart display region for displaying the chart, and the method further comprises:
deleting a chart corresponding to a first target channel scenario from the chart display region in response to a delete operation for the first target channel scenario in the chart display region.

15. The method of claim 1, wherein the information display page comprises a chart display region for displaying the chart, and the method further comprises:
adding and displaying a chart corresponding to a second target channel scenario in the chart display region in response to an addition operation for the second target channel scenario in the chart display region, wherein the second target channel scenario is a channel scenario different from all channel scenarios in the chart before a response to a delete operation.

16. An apparatus for information display, comprising:
at least a processor; and
a non-transitory memory with instructions thereon,
wherein the instructions upon execution by the processor, cause the processor to:
display charts corresponding to different channel scenarios in response to a trigger operation for conversion analysis of a target business in an information display page,
wherein the target business comprises a plurality of business process nodes, and a chart corresponding to a channel scenario comprises a maximum churn rate among all business process nodes in the channel scenario determined based on data corresponding to the channel scenario.

17. The apparatus of claim 16, wherein the information display page comprises a chart display region and a non-chart display region, the chart display region is used to display the chart, the non-chart display region comprises a comparison component, and the comparison component is used to support a user to configure the channel scenario and a display order of charts corresponding to all channel scenarios in the chart display region.

18. The apparatus of claim 16, wherein the non-chart display region further comprises a chart type switching component, and the instructions upon execution by the processor, further cause the processor to:
displaying the chart corresponding to the channel scenario in a first display style, wherein the first display style comprises a chart display type determined based on the chart type switching component, and the chart display type comprises a bar display type or a funnel graphic display type.

19. The apparatus of claim 18, wherein the first display style further comprises a color style that distinguishes the different channel scenarios.

20. A non-transitory computer-readable storage medium storing instructions that cause at least a processor to:
display charts corresponding to different channel scenarios in response to a trigger operation for conversion analysis of a target business in an information display page,
wherein the target business comprises a plurality of business process nodes, and a chart corresponding to a channel scenario comprises a maximum churn rate among all business process nodes in the channel scenario determined based on data corresponding to the channel scenario.
